(19) United States
(12) Patent Application Publication
(10) Pub. No.: US 2026/0278849 A1
(43) Pub. Date: Sep. 17, 2026

(54) A METHOD, AN APPARATUS AND A COMPUTER PROGRAM PRODUCT FOR NEURAL NETWORK COMPLEMENTARY REPRESENTATIONS

(71) Applicant: Nokia Technologies Oy, Espoo (FI)

(72) Inventor: Hamed REZAZADEGAN TAVAKOLI, Espoo (FI)

(21) Appl. No.: 19/473,930

(22) PCT Filed: Feb. 20, 2024
(86) PCT No.: PCT/EP2024/054244

§ 371 Date: Oct. 9, 2025

Related U.S. Application Data
(60) Provisional application No. 63/495,595, filed on Apr. 12, 2023.

(51) Int. Cl. G06T 9/00; G06N 3/0455; G06N 3/08

(52) U.S. Cl. CPC G06T 9/002; G06N 3/0455; G06N 3/08

(57) ABSTRACT

The embodiments relate to method for encoding and decoding. The method for decoding comprises deploying a first neural network representation with a first number of bits; receiving at least some of the parameters of a second neural network representation with a second number of bits and information relating to the second neural network representation; decoding from the information an indication that the second neural network representation is to be processed to complement the first neural network representation; creating a third neural network representation according to the first neural network representation and said at least some of the parameters of the second neural network representation; and deploying the third neural network representation. The embodiments also relate to technical equipment for implementing the methods.

### TECHNICAL FIELD

The present solution generally relates to neural networks.

### BACKGROUND

Neural network is widely used example of machine learning. The operation of neural network—as well as other machine learning models—is based on training. A neural network is able to configure itself based on training data, which is input to the system. After training, the neural network makes predictions and/or decisions over the received input according to its configuration.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for training and obtaining a first neural network representation with a first number of bits; means for transmitting the first neural network representation to a decoder; means for training and obtaining a second neural network representation with a second number of bits, the second neural network representation complementing the trained first neural network representation to obtain a third neural network representation; means for transmitting at least some of the parameters of the second neural network representation to a decoder according to which the second neural network representation is deployable at the decoder; and means for transmitting information relating to the second neural network to the decoder, the information comprising at least an indication that the second neural network representation is to be processed to complement the first neural network representation.

According to a second aspect, there is provided a method, comprising training and obtaining a first neural network representation with a first number of bits; transmitting the first neural network representation to a decoder; training and obtaining a second neural network representation with a second number of bits, the second neural network representation complementing the trained first neural network representation to obtain a third neural network representation; transmitting at least some of the parameters of the second neural network representation to a decoder according to which the second neural network representation is deployable at the decoder; and transmitting information relating to the second neural network to the decoder, the information comprising at least an indication that the second neural network representation is to be processed to complement the first neural network representation.

According to a third aspect, there is provided an apparatus comprising at least one processor, memory including computer program code, the memory and the computer program code configured to, with the at least one processor, cause the apparatus to perform at least the following: train and obtain a first neural network representation with a first number of bits; transmit the first neural network representation to a decoder; means for training and obtaining a second neural network representation with a second number of bits, the second neural network representation complementing the trained first neural network representation to obtain a third neural network representation; transmit at least some of the parameters of the second neural network representation to a decoder according to which the second neural network representation is deployable at the decoder; and transmit information relating to the second neural network to the decoder, the information comprising at least an indication that the second neural network representation is to be processed to complement the first neural network representation.

According to a fourth aspect, there is provided computer program product comprising computer program code configured to, when executed on at least one processor, cause an apparatus or a system to: train and obtain a first neural network representation with a first number of bits; transmit the first neural network representation to a decoder; means for training and obtaining a second neural network representation with a second number of bits, the second neural network representation complementing the trained first neural network representation to obtain a third neural network representation; transmit at least some of the parameters of the second neural network representation to a decoder according to which the second neural network representation is deployable at the decoder; and transmit information relating to the second neural network to the decoder, the information comprising at least an indication that the second neural network representation is to be processed to complement the first neural network representation.

According to a fifth aspect, there is provided an apparatus for decoding, the apparatus comprising means for deploying a first neural network representation with a first number of bits; means for receiving at least some of the parameters of a second neural network representation with a second number of bits and information relating to the second neural network representation; means for decoding from the information an indication that the second neural network representation is to be processed to complement the first neural network representation; means for creating a third neural network representation according to the first neural network representation and said at least some of the parameters of the second neural network representation; and means for deploying the third neural network representation.

According to a sixth aspect, there is provided a method for decoding, the method comprising deploying a first neural network representation with a first number of bits; receiving at least some of the parameters of a second neural network representation with a second number of bits and information relating to the second neural network representation; decoding from the information an indication that the second neural network representation is to be processed to complement the first neural network representation; creating a third neural network representation according to the first neural network representation and said at least some of the parameters of the second neural network representation; and deploying the third neural network representation.

According to a seventh aspect, there is provided an apparatus comprising at least one processor, memory including computer program code, the memory and the computer program code configured to, with the at least one processor, cause the apparatus to perform at least the following: deploy a first neural network representation with a first number of bits; receive at least some of the parameters of a second neural network representation with a second number of bits and information relating to the second neural network representation; decode from the information an indication that the second neural network representation is to be processed to complement the first neural network representation; create a third neural network representation according to the first neural network representation and said at least some of the parameters of the second neural network representation; and deploy the third neural network representation.

According to an eighth aspect, there is provided computer program product comprising computer program code configured to, when executed on at least one processor, cause an apparatus or a system to deploy a first neural network representation with a first number of bits; receive at least some of the parameters of a second neural network representation with a second number of bits and information relating to the second neural network representation; decode from the information an indication that the second neural network representation is to be processed to complement the first neural network representation; create a third neural network representation according to the first neural network representation and said at least some of the parameters of the second neural network representation; and deploy the third neural network representation.

According to an embodiment, the information comprises information to enable decoding a bit incremental model.

According to an embodiment, the information comprises at least one of the following: bit-width of a model increment; number of left or right shifts required to obtain a correct increment loading; bit-width and precision of a complete model.

According to an embodiment, the information is encoded to a model parameter set or a layer parameter set of the neural network compression bitstream.

According to an embodiment, said at least some of the parameters comprises the least significant portion of the second neural network representation being compressed.

According to an embodiment, said at least some of the parameters comprises the most significant portion of the second neural network representation being compressed as weight updates.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows a simplified example of a neural network;

FIG. 2 shows an example of a Neural Network Representation (NNR) unit;

FIG. 3 shows an example of NNR bitstream;

FIG. 4 shows an example of a bit-incremental deployment process according to an embodiment;

FIG. 5 is a flowchart illustrating a method for encoding according to an embodiment;

FIG. 6 is a flowchart illustrating a method for decoding according to an embodiment;

FIG. 7 shows an example of a computing system for encoding;

FIG. 8 shows an example of a computing system for decoding; and

FIG. 9 shows an apparatus according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

The present embodiments are targeted to a bit-incremental neural network learning and deployment, as well as high-level syntax and processes. Before discussing the present embodiments in more detailed manner, a short reference to related technology is given.

In the context of machine learning, a neural network (NN) is a computation graph consisting of several layers of computation, i.e., several portions of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

Two widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers and provide output to one or more of following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of devices, such as mobile phones. Examples include image and video analysis and processing, social media data analysis, device usage data analysis, etc.

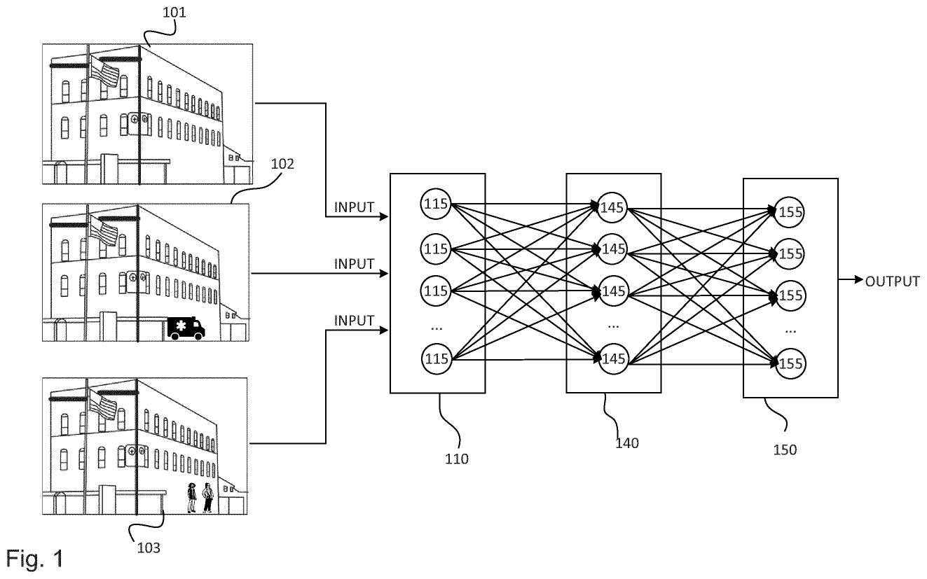

An example of a neural network is illustrated in FIG. 1. The neural network comprises a sequence of one or more components 110, 140, 150. These components can be called layers. Each component 110, 140, 150 may comprise one or more units 115, 145, 155, i.e., neurons, for performing one or more other operations (such as selection or gating, modulation, etc.). First layer 110, i.e., an input layer, receives an input, for example one or more images 101, 102, 103. The units 115 of the input layer 110 perform respective operations for the input data and provide output for units 145 of the subsequent layer 140. These units 145 perform their operation on the data received from the input layer 110, and provide output for units 155 of the subsequent layer 150. There can be a plurality of subsequent layers after the input layer, but for simplicity only two has been illustrated in FIG. 1. Finally the neural network comprises an output, which can be a decision or an interpretation performed based on the input data.

One of the important properties of neural networks (and other machine learning tools) is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

Training a neural network is an optimization process. The goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data may be split into at least two sets, the training set and the validation set. The training set is used for training the network, i.e., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set but performs poorly on a set not used for tuning its parameters.

Lately, neural networks have been used for compressing and de-compressing data such as images, i.e., in an image codec. The most widely used architecture for realizing one component of an image codec is the auto-encoder, which is a neural network consisting of two parts: a neural encoder and a neural decoder. The neural encoder takes as input an image and produces a code which requires less bits than the input image. This code may be obtained by applying a binarization or quantization process to the output of the encoder. The neural decoder takes in this code and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These distortion metrics are meant to be correlated to the human visual perception quality, so that minimizing or maximizing one or more of these distortion metrics results into improving the visual quality of the decoded image as perceived by humans.

Incremental deployment of a neural network is a topic of discussion in multiple standardization activities and industry forums. For example, in 3GPP/SA4, deploying a neural network per-layer or partially is discussed. In neural network compression standard, ISO/IEC 15938-17 in MPEG, the bitstream design allows partial per-layer deployment. Per-layer or layer-wise partial deployment of a neural network is discussed as a way of deploying a neural networks at scale to speed up the computation process. For that, some layers of the neural network are deployed and the device begins computing meanwhile receiving the rest of the neural network. This may allow early start of the computing but may yield to the waiting time for obtaining the results that requires complicated processes of caching intermediate computes and a complicated computation architectures to be addressed.

The present embodiments are related to an orthogonal approach to per-layer or partial neural network deployment consisting of a bit-incremental model training and deployment. The bit-incremental model training results in a for example 32-bit model that contains a 16-bit model that contains a 8-bit model which contains a 4-bit model where each lower precision model can work independently and be complemented to obtain a higher precision model. It means that it is possible to deploy a 4-bit model that works fine and send another 4-bit complementary information to obtain 8-bit model. It is to be not noticed that term “model” refers to a neural network, whereupon these terms can be used interchangeably. The solution allows a complete working model being deployed on the device, which is enhanced overtime by receiving complementing bit information. Also, the present embodiments are related to the high-level syntax and process of decoding such neural network deployment.

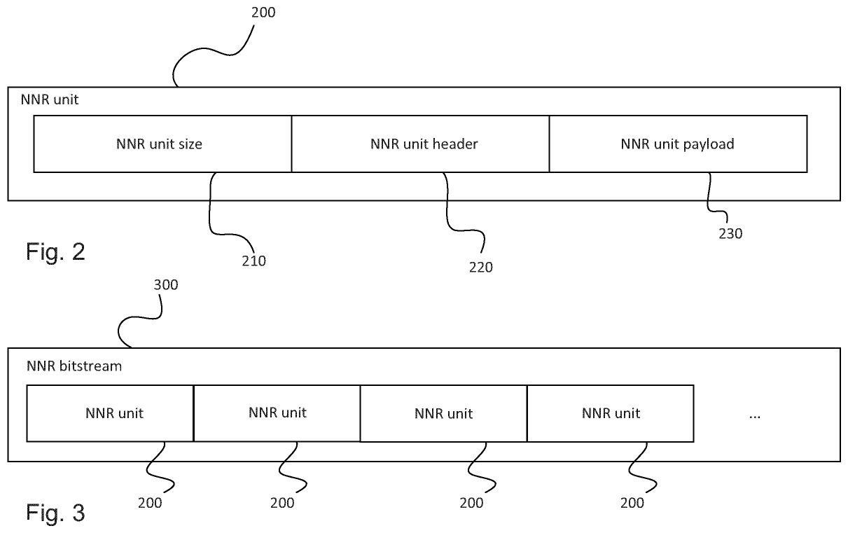

The NNR (Neural Network Representation) bitstream comprises one or more NNR units. A NNR unit is a data structure for carrying neural network data and related metadata. NNR units carry compressed or uncompressed information about neural network metadata, topology information, complete or partial layer data, filters, kernels, biases, quantized weights, tensors of alike. FIG. 2 shows an example of an NNR unit 200 consists of following data elements:
NNR unit size 210 signaling the total byte size of the NNR unit, including the NNR unit size;
NNR unit header 220 containing information about the NNR type and related metadata;
NNR unit payload 230 containing compressed or uncompressed data related to the neural network.

FIG. 3 illustrates an example of a NNR bitstream consists of a sequence of NNR units 200 as shown in FIG. 3.

There are various NNR units types, e.g., a model parameter set and a layer parameter set:

NNR model parameter set unit header syntax:

| | Descriptor |
|---|---|
| nnr_model_parameter_set_unit_header( ) { | |
| nnr_reserved_zero_0bit | u(0) |
| } | |

NNR layer parameter set unit header syntax:

| | Descriptor |
|---|---|
| nnr_layer_parameter_set_unit_header( ) { | |
| lps_self_contained_flag | u(1) |
| nnr_reserved_zero_7_bits | u(7) |
| } | |

Model parameter set and a layer parameter set are carrying model level and layer level information of a neural network.

The concept of signalling some information to indicate a quantized model or a model of mixed-precision is known. This means that one can signal the precision information inside data units at model parameter set or layer parameter set. The present embodiments relate to signalling information to allow bit-incremental model deployment.

As discussed above, in the bit-incremental deployment of a neural network, for example, a 4-bit neural network is deployed initially and later a complementary 4-bit neural network may be provided to allow an 8-bit neural network to be obtained. According to another example, the complementary model can be higher, e.g., a 12-bit neural network that complements a 4-bit neural network to obtain a 16-bit neural network. In other words, a N-bit precision model is trained to encapsulate a working M-bit precision model, whereby the M-bit precision model can work independently at an acceptable performance. For example, a 32-bit model can be trained that includes a 16-bit model, which includes a 8-bit model and so on.

The present embodiments comprises a minimum high-level syntax and decoding steps, and the necessary additions to a bitstream to allow model deployment using neural network compression standard or any other related alternative deployment framework.

The aim of the present embodiments is achieved by training a neural network at different bit-precisions such that the higher bit-precision includes the lower bit-precision, e.g., a 8-bit neural network, considering a binary representation, consists of a higher significant 4-bit (4+) (i.e., most significant bits, MSB) and a lower significant 4-bit (4−) (i.e., least significant bits, LSB) components, or e.g., a 16-bit neural network consists of a 4-bit and 12-bit components. Similarly, the same neural network architecture, may be trained to have different bit representations, e.g., 32-bit, 16-bit, 8-bit and 4-bit, where the 8-bit contains the 4-bit representation.

The training of an 8-bit model that includes a working 4-bit representation could be achieved by initially obtaining a 4-bit representation. This 4-bit representation will be used to be the (4−)-bit of a 8-bit representation. To obtain an 8-bit representation that includes the 4-bit representation as the (4−)-bit representation of the 8-bit model, the (4−)-bit of the 8-bit representation is fixed and is equal to the 4-bit model. That is, for example, (4−)-bit is initialized using the pre-trained 4-bit model, and during the training the (4−)-bit is fixed through masking or re-initialization to ensure gradient changes affecting the (4+)-bit.

Similar approach can be used for obtaining 16-bit, 32-bit, and other representations that include a working lower representation. Such representation is called as n/m-bit incremental representation. That is an n-bit precision model that embeds a working m-bit representation. For example, 8/4 bit incremental model, is an 8-bit model that consist of a (4−)-bit model, where the (4−)-bit model could work as a standalone 4-bit model. The representation may be float or integer.

According to a first embodiment for a decoding, to enable deployment of n/m-bit incremental representation that embeds a m-bit working representation in bit-incremental fashion, the following decoding process is performed on the receiver.

The decoder has already received an m-bit representation that is running on the device. The decoder receives a complementing model having (n−m) bits with an indicator that the model complies with n/m-bit incremental deployment. For each variable number X of a weight tensor W of the (n−m)-bit model, the following operation happens: the number X is shifted and an or-operation is performed with the corresponding variable in the system, noted as X_h:

X << m
X_h <- X_h | X

According to a second embodiment for a decoding, to enable deployment of n/m-bit incremental, the decoder receives information about the overall model precision, e.g., n indicating a model of n-bit, or 8-bit that is going to be a model of 8-bit to be deployed. The decoder receives the value of m, indicating that m-bit sub-model is available, e.g., 4-bit indicates that a 4-bit sub-precision model is available. The decoder receives the amount of left shifts s, required to correctly load the sub-precision model into the n-bit model. For example, a shift value of 0 indicates that the received model will be directly loaded into the memory. And a non-zero value indicates that each variable in the weight matrices may have to be shifted to the left with that shift value amount, and an bitwise-OR operator is used to fuse it to the existing loaded model. When the device ensures that the model memory is all zero at initialization, the bitwise-OR operator could be used to load a model with accompanying shift-value of 0.

To enable the bit-incremental representation deployment, the following information shall be present in the bitstream or with an out-of-band mechanism. The “out-of-band” parameter signalling means that information, such as parameters are provided through other data channels than the media data themselves.

The semantical elements for the purposes of the present solution are provided next:
model_quantized determines if a neural network model is in integer space or in float space. The implementation of model_quantized can be, for example, one bit flag that when set equal to one indicates the model is integer and otherwise the model is float. Alternative could be an enumeration that allows integer, float and double space indications.
model_precision indicates the precision of a model, for example, if a model is 2-bit, 4-bit, 8-bit, 16-bit, 32-bit or alike. The model_precision may contain the bit-precision as an integer or be defined as an enumeration to a list of possible precisions that are available.
model_inc_bit_dep indicates if the current model is part of an incremental deployment. When set to 1, model_inc_bit_dep indicates that the model being currently received shall be processed to complement the model being currently deployed.
model_bit_shift_left signals the number of left shifts which may be needed by the values of the variables in the model to reconstruct the true model.
model_bit_order is used with model_inc_bit_dep. When model_inc_bit_dep is set to 1, the model_bit_order indicates the bit order of the provided model, for example, if it is the least significant portion (m-bit) or the most significant portion ((n-m)-bit) of the n/m-bit incremental model.
model_inc_precision indicates the precision of an incremental chunk, a value of m indicates a m-bit model as part of a n/m-incremental model. For example, a value of 4 in a 16/4 incremental model means that a sub-model of precision 4 is provided as part of the 16-bit model.

The minimum requirement of the information to enable the bit-incremental representation deployment includes model_precision, model_inc_bit_dep, model_bit_shift_left.

An alternative method for providing information, such as the model bitwidth information, precisions, model_inc_bit_dep could be to provide the information as part of a naming convention referring to the model name. In such case, parsing the model name would allow obtaining the required information. The model name may be part of the model_parameter_set. Alternatively, a variable name may include similar information as part of the layer parameter set to allow carriage of such information at layer level.

The semantical elements defined above may be part of the model_parameter_set and/or layer_parameter_set of the neural network compression standard to allow the proper bit incremental deployment.

Implementing the bit-incremental deployment inside the bitstream (i.e., NNR/NNC bitstream) at model level, the following additions to the model_parameter_set are defined:

| | Descriptor |
|---|---|
| nnr_model_parameter_set_unit_payload( ) { | |
| topology_carriage_flag | u(1) |
| mps_sparsification_flag | u(1) |
| mps_pruning_flag | u(1) |
| mps_unification_flag | u(1) |
| mps_decomposition_performance_map_flag | u(1) |
| mps_quantization_method_flags | u(3) |
| mps_topology_indexed_reference_flag | u(1) |
| if( general_profile_idc == 1 ) { | |
| base_model_id_present_flag | u(1) |
| validation_set_performance_present_flag | u(1) |
| metric_type_performance_map_valid_flag | u(1) |
| nnr_pre_flag | u(1) |
| precision_flag | u(1) |
| nnr_reserved_zero2bits | u(2) |
| if( precision_flag == 1 ) { | |
| model_precision | u(3) |
| model_quantized | u(1) |
| model_inc_precision | u(1) |
| if (model_inc_precision == 1) { | |
| model_inc_precision | u(3) |
| model_bit_shift_left | u(5) |
| nnr_reserved_zero_5bits | u(3) |
| } | |
| else | |
| nnr_reserved_zero3bits | u(3) |
| } | |
| if( base_model_id_present_flag == 1 ) | |
| base_model_id | st(v) |
| if( validation_set_performance_present_flag | |
| == 1 \|\| | |
| metric_type_performance_map_valid_flag == 1 ) | |
| performance_metric_type | st(v) |
| } | |
| else | |
| nnr_reserved_zero_7bits | u(7) |
| if( (mps_quantization_method_flags & | |
| NNR_QSU) == NNR_QSU \|\| | |
| (mps_quantization_method_flags & NNR_QCB) | |
| == NNR_QCB ) { | |
| mps_qp_density | u(3) |
| mps_quantization_parameter | i(13) |
| } | |
| if( mps_sparsification_flag == 1 ) | |
| sparsification_performance_map( ) | |
| if( mps_pruning_flag == 1 ) | |
| pruning_performance_map( ) | |
| if( mps_unification_flag == 1 ) | |
| unification_performance_map( ) | |
| if( mps_decomposition_performance_map_flag | |
| == 1 ) | |
| decomposition_performance_map( ) | |
| if( general_profile_idc == 1 && | |
| validation_set_performance_present_flag | |
| == 1 ) | |
| validation_set_performance | flt(32) |
| byte_alignment( ) | |
| } | |

According to an example implementation, model_precision can be defined as follows:

| model_{—} | | |
|---|---|---|
| precision | Identifier | Description |
| 0x00 | NNR_TWO_BIT | 2-bit model representation |
| 0x01 | NNR_THREE_BIT | 3-bit model representation |
| 0x02 | NNR_FOUR_BIT | 4-bit model representation |
| 0x03 | NNR_EIGHT_BIT | 8-bit model representation |
| 0x04 | NNR_SIXTEEN_BIT | 16-bit model representation |
| 0x05 | NNR_THIRTYTWO_BIT | 32-bit model representation |
| 0x06, 0x07 | NNR_RESERVED | Reseved |

In case of a mixed precision model, the following modifications may be required to the layer_parameter_set:

| | Descriptor |
|---|---|
| nnr_layer_parameter_set_unit_payload( ) { | |
| lps_sparsification_flag | u(1) |
| lps_pruning_flag | u(1) |
| lps_unification_flag | u(1) |
| lps_quantization_method_flags | u(3) |
| nnr_reserved_zero_2bits | u(2) |
| if( general_profile_idc == 1 ) { | |
| precision_flag | u(1) |
| nnr_reseved_zero 7_bits | u(7) |
| if( precision_flag == 1 ) { | |
| model_precision | u(3) |
| model_quantized | u(1) |
| model_inc_precision | u(1) |
| if (model_inc_precision == 1) { | |
| model_inc_precision | u(3) |
| model_bit_shift_left | u(5) |
| nnr_reserved_zero_5bits | u(3) |
| } | |
| else | |
| nnr_reserved_zero3bits | u(3) |
| } | |
| byte_alignment( ) | |
| } | |

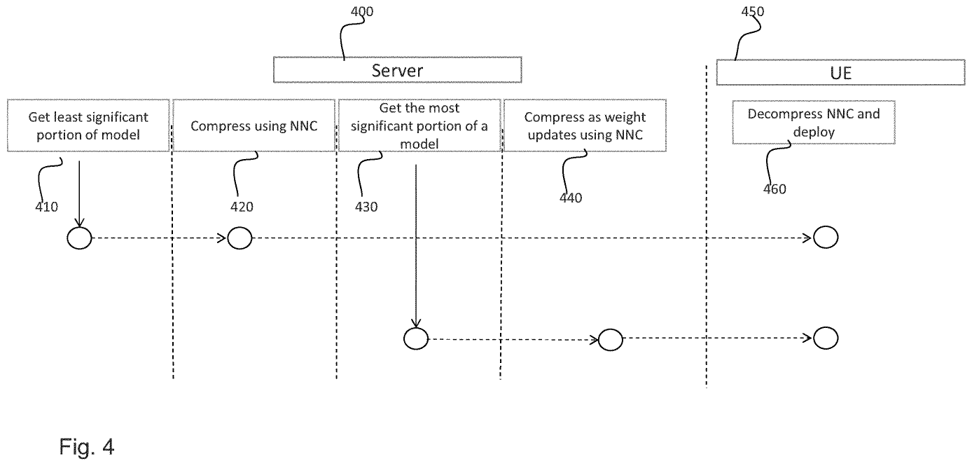

FIG. 4 illustrates an example of a process according to an embodiment, where a bit-incremental deployment may consist of using the current NNC/ISO/IEC 15938-17 standard and using incremental updates. The process includes obtaining the least significant portion of the parameters of the complementary model and deploying it as a compressed neural network representation using NNC or similar standard. The most significant portion of the parameters can be deployed as a weight update to the original model.

As shown in FIG. 4, a server 400, comprising an encoder, gets 410 the least significant portion of the model and compresses 420 it using NNC. The least significant portion of the model is determined as the least significant part of a binary number e.g. the (4−)-bit part of a 8/4-model. The server 400 also gets 430 the most significant portion of the model and compresses 440 it as weight updates using the NNC. The most significant portion of the model is determined similar to the most significant part of a binary number e.g. the (4+)-bit part of a 8/4 model. Both compressed models are received by the user equipment (UE) 450, comprising a decoder, which decompresses 460 the models with NNC and deploys them.

This arrangement may still depend on the semantical elements that are proposed inside the NNC bitstream. In yet another alternative possibility, the required information may be available as an out-of-band signal. In yet another alternative, the required information may be available as part of the model name information that could be available as part of the bitstream or as out-of-band signal.

To obtaining a neural network model at different bit-precisions follows the same principle as training a neural network model for specific precisions. To do that, the precision of a model is limited to a preferred precision, for example, a model trained with float 32 is limited to a float 16 and the inference accuracy is ensured to be remained intact. This can be achieved by simulation or hardware support. Similar concept can be applied to obtain a quantized model. For example, to obtain a 4-bit quantized model, similar concept is applied in quantization aware training. That is, the bit-width is limited to 4 and in training the backpropagation is performed using float information and in forward path the neural network is quantized to 4-bit width.

In training to obtain the n/m-bit model, the smaller sub-model that has m-bit is initially obtained. Then, the model with n-bit precision that embeds the m-bit model is trained. In this approach, the backpropagation will happen for the n-bit model. However, during the forward path the previously trained m-bit model is embedded into the n-bit model to ensure that the m-bit model is preserved. For example, to train a 8/4-bit quantized model, a 4-bit model is trained in quantization-aware fashion. “Then, training of an 8-bit quantized model is started. The training procedure starts with loading or converting the 4-bit model into 8-bit model. For example, the 4-bit model is iterated over each variable, and the 4-bit model is converted to 8-bit that could done by padding 4-bit zeros to the left. Alternatively, an 8-bit model could be initialized and iterated over the variables, wherein the 4-bits from the lower precision model could be loaded to the right most 4-bits of the model. The training will follow the same principle of quantization aware training, described above with the addition that in each forward path, the 4-bits of the lower precision model is reloaded or preserved e.g., by masking the bits during the backpropagation. The process can happen with software or can be implemented on hardware.

The structure of the n/m-bit neural network model follows any other neural network structures, and both the n-bit model and the sub-precision m-bit model have the same architecture. In other words, they are the same model architectures in different bit-width precision.

The functionality discussed above can be implemented by a data processing device that is configured to train a neural network and to generate an NNR bitstream comprising a model header information for identifying a model of the NN, a layer header information for identifying one or more layers of the NN, and weight information for the layers. In addition, the data processing unit is configured to encode layer structure information for the neural network, and a precision parameter indicating the precision of the neural network model, and a new parameter indicating if the model is part of an incremental deployment.

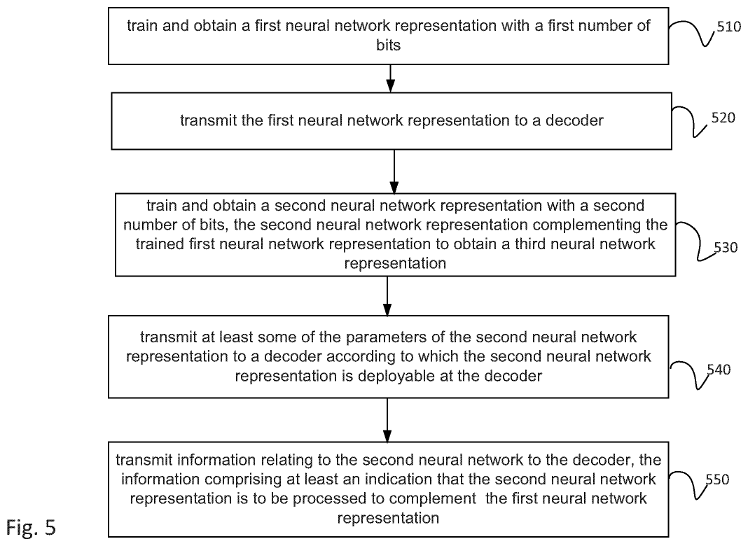

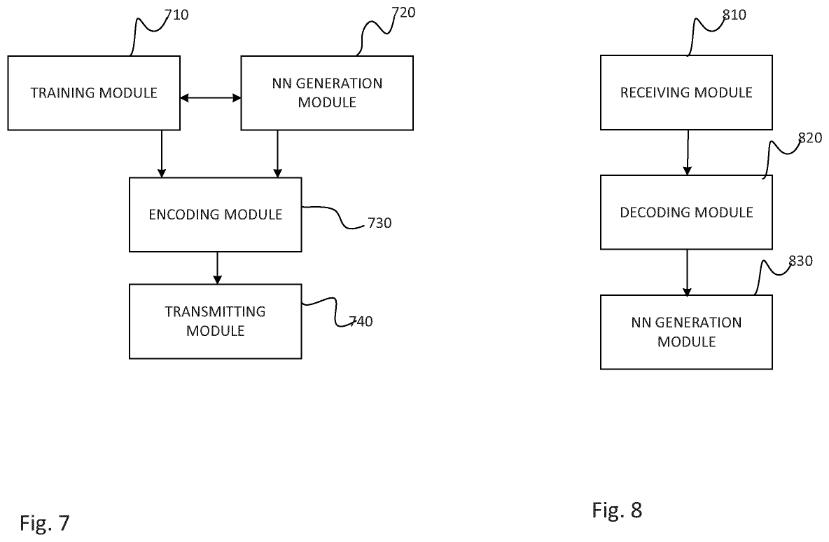

The method for encoding according to an embodiment is shown in FIG. 5. The method generally comprises training 510 and obtaining a first neural network representation with a first number of bits; transmitting 520 the first neural network representation to a decoder; training 530 and obtaining a second neural network representation with a second number of bits, the second neural network representation complementing the trained first neural network representation to obtain a third neural network representation; transmitting 540 at least some of the parameters of the second neural network representation to a decoder according to which the second neural network representation is deployable at the decoder; and transmitting 550 information relating to the second neural network to the decoder, the information comprising at least an indication that the second neural network representation is to be processed to complement the first neural network representation. Any of the data being transmitted can have been encoded into a bitstream. Each of the steps can be implemented by a respective module of a computer system. An example of such computer system is illustrated in FIG. 7, comprising a training module 710, a neural network (NN) generation module 720, an encoding module 730 and a transmitting module 740 comprising a network connection to a receiver.

An apparatus according to an embodiment comprises means for training and obtaining a first neural network representation with a first number of bits; means for transmitting the first neural network representation to a decoder; means for training and obtaining a second neural network representation with a second number of bits, the second neural network representation complementing the trained first neural network representation to obtain a third neural network representation; means for transmitting at least some of the parameters of the second neural network representation to a decoder according to which the second neural network representation is deployable at the decoder; and means for transmitting information relating to the second neural network to the decoder, the information comprising at least an indication that the second neural network representation is to be processed to complement the first neural network representation. The means comprises at least one processor, and a memory including a computer program code, wherein the processor may further comprise processor circuitry. The memory and the computer program code are configured to, with the at least one processor, cause the apparatus to perform the method of FIG. 5 according to various embodiments.

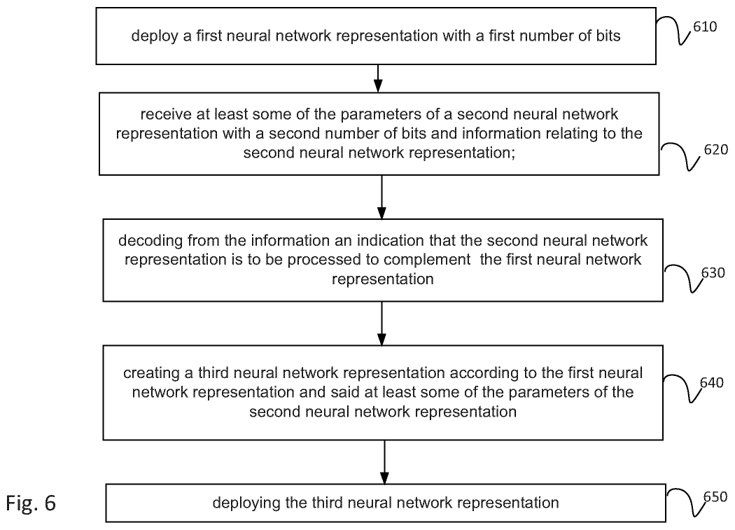

The method for decoding according to an embodiment is shown in FIG. 6. The method generally comprises deploying 610 a first neural network representation with a first number of bits; receiving 620 at least some of the parameters of a second neural network representation with a second number of bits and information relating to the second neural network representation; decoding 630 from the information an indication that the second neural network representation is to be processed to complement the first neural network representation; creating 640 a third neural network representation according to the first neural network representation and said at least some of the parameters of the second neural network representation; and deploying 650 the third neural network representation. Any of the data being received can have been encoded into a bitstream. Each of the steps can be implemented by a respective module of a computer system. An example of such computer system is illustrated in FIG. 8, comprising a receiving module 810, a decoding module 820, and a neural network (NN) generation module 830. The receiving module 810 comprises a network connection to a sender.

An apparatus according to an embodiment comprises means for deploying a first neural network representation with a first number of bits; means for receiving at least some of the parameters of a second neural network representation with a second number of bits and information relating to the second neural network representation; means for decoding from the information an indication that the second neural network representation is to be processed to complement the first neural network representation; means for creating a third neural network representation according to the first neural network representation and said at least some of the parameters of the second neural network representation; and means for deploying the third neural network representation. The means comprises at least one processor, and a memory including a computer program code, wherein the processor may further comprise processor circuitry. The memory and the computer program code are configured to, with the at least one processor, cause the apparatus to perform the method of FIG. 6 according to various embodiments.

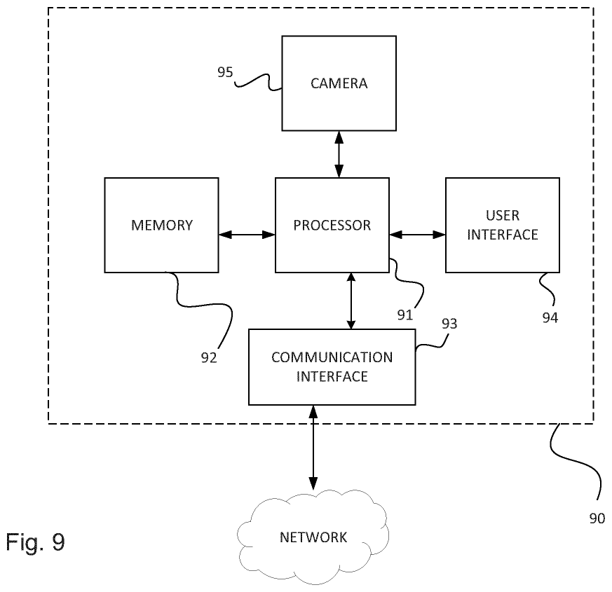

FIG. 9 illustrates an apparatus according to an embodiment. The apparatus can be function as a user equipment for the purposes of the present embodiments. The apparatus 90 comprises a main processing unit 91, a memory 92, a user interface 94, a communication interface 93. The apparatus according to an embodiment, shown in FIG. 7, may also comprise a camera module 95. Alternatively, the apparatus may be configured to receive image and/or video data from an external camera device over a communication network. The memory 92 stores data including computer program code in the apparatus 90. The computer program code is configured to implement the method according to various embodiments by means of various computer modules. The camera module 95 or the communication interface 93 receives data, in the form of images or video stream, to be processed by the processor 91. The communication interface 93 forwards processed data, i.e., the image file, for example to a display of another device, such a virtual reality headset. When the apparatus 90 is a video source comprising the camera module 95, user inputs may be received from the user interface.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-16. (canceled)

17. An apparatus comprising: at least one processor, and at least one memory storing instructions that, when executed with the at least one processor, cause the apparatus to perform at least the following: training and obtaining a first neural network representation with a first number of bits; transmitting the first neural network representation to a decoder; training and obtaining a second neural network representation with a second number of bits, the second neural network representation complementing the trained first neural network representation to obtain a third neural network representation; transmitting at least some of the parameters of the second neural network representation to a decoder according to which the second neural network representation is deployable at the decoder; and transmitting information relating to the second neural network to the decoder, the information comprising at least an indication that the second neural network representation is to be processed to complement the first neural network representation.

18. The apparatus according to claim 17, wherein the information comprises information to enable decoding a bit incremental model.

19. The apparatus according to claim 18, wherein the information comprises at least one of the following: bit-width of a model increment; number of left or right shifts required to obtain a correct increment loading; bit-width and precision of a complete model.

20. The apparatus according to claim 17, wherein the instructions, when executed with the at least one processor, further cause the apparatus to perform: encoding the information to a model parameter set or a layer parameter set of the neural network compression bitstream.

21. The apparatus according to claim 17, wherein the at least some of the parameters comprises the least significant portion of the second neural network representation being compressed.

22. The apparatus according to claim 17, wherein the at least some of the parameters comprises the most significant portion of the second neural network representation being compressed as weight updates.

23. An apparatus comprising: at least one processor, and at least one memory storing instructions that, when executed with the at least one processor, cause the apparatus to perform at least the following: deploying a first neural network representation with a first number of bits; receiving at least some of the parameters of a second neural network representation with a second number of bits and information relating to the second neural network representation; decoding from the information an indication that the second neural network representation is to be processed to complement the first neural network representation; creating a third neural network representation according to the first neural network representation and said at least some of the parameters of the second neural network representation; and deploying the third neural network representation.

24. The apparatus according to claim 23, wherein the information comprises information to enable decoding a bit incremental model.

25. The apparatus according to claim 24, wherein the information comprises at least one of the following: bit-width of a model increment; number of left or right shifts required to obtain a correct increment loading; bit-width and precision of a complete model.

26. The apparatus according to claim 23, wherein the instructions, when executed with the at least one processor, further cause the apparatus to perform: decoding the information from a model parameter set or a layer parameter set of the neural network compression bitstream.

27. The apparatus according to claim 23, wherein the at least some of the parameters comprises the least significant portion of the second neural network representation being compressed.

28. The apparatus according to claim 23, wherein the at least some of the parameters comprises the most significant portion of the second neural network representation being compressed as weight updates.

29. An method comprising: deploying a first neural network representation with a first number of bits; receiving at least some of the parameters of a second neural network representation with a second number of bits and information relating to the second neural network representation; decoding from the information an indication that the second neural network representation is to be processed to complement the first neural network representation; creating a third neural network representation according to the first neural network representation and said at least some of the parameters of the second neural network representation; and deploying the third neural network representation.

30. The method according to claim 29, wherein the information comprises information to enable decoding a bit incremental model.

31. The method according to claim 30, wherein the information comprises at least one of the following: bit-width of a model increment; number of left or right shifts required to obtain a correct increment loading; bit-width and precision of a complete model.

32. The method according to claim 29, further comprising: decoding the information from a model parameter set or a layer parameter set of the neural network compression bitstream.

33. The method according to claim 29, wherein the at least some of the parameters comprises the least significant portion of the second neural network representation being compressed.

34. The method according to claim 29, wherein the at least some of the parameters comprises the most significant portion of the second neural network representation being compressed as weight updates.
